(19) United States
(12) Patent Application Publication
(10) Pub. No.: US 2026/0073929 A1
(43) Pub. Date: Mar. 12, 2026

(54) BONE CONDUCTED SIGNAL GUIDED SPEECH ENHANCEMENT FOR VOICE ASSISTANT ON EARBUDS

(71) Applicant: Google LLC, Mountain View, CA (US)

(72) Inventors: Jens Heitkaemper, Mountain View, CA (US); Joseph Peter Caroselli, JR., Palo Alto, CA (US); Max Mckinnon, Mountain View, CA (US); Arun Narayanan, Milpitas, CA (US); Nathan David Howard, Mountain View, CA (US)

(73) Assignee: Google LLC, Mountain View, CA (US)

(21) Appl. No.: 19/281,540

(22) Filed: Jul. 25, 2025

Related U.S. Application Data
(60) Provisional application No. 63/694,101, filed on Sep. 12, 2024.

(51) Int. Cl. G10L 21/0208; G10L 15/01; G10L 15/06; G10L 25/30; G10L 25/78; H04R 1/10

(52) U.S. Cl. CPC G10L 21/0208; G10L 15/01; G10L 15/063; G10L 25/78; G10L 2021/02082; G10L 25/30; H04R 1/1016; H04R 2460/13

(57) ABSTRACT

A method includes receiving, as input to an initial block of a stack of self-attention blocks of a speech enhancement model, an input concatenating short-time Fourier transform (STFT) coefficients for a single channel noisy input signal and upscaled STFT coefficients of a bone conducted signal (BCS) recorded by an accelerometer. The method includes generating, using a final block of the stack of self-attention blocks, an un-masked output based on the input concatenating STFT coefficients for the single channel noisy input signal. The method includes generating, using a masking layer, a masked single channel noisy input signal based on the un-masked output. The method includes generating, using an inverse STFT layer, enhanced input speech features corresponding to a target utterance based on the STFT coefficients for the single channel noisy input signal and the masked single channel noisy input signal.

### CROSS REFERENCE TO RELATED APPLICATIONS

This U.S. patent application claims priority under 35 U.S.C. § 119(e) to U.S. Provisional Application 63/694,101, filed on Sep. 12, 2024. The disclosure of this prior application is considered part of the disclosure of this application and is hereby incorporated by reference in its entirety.

### TECHNICAL FIELD

This disclosure relates to bone conducted signal guided speech enhancement for a voice assistant on earbuds.

### BACKGROUND

The widespread adoption of voice assistants has made automatic speech recognition (ASR) systems increasingly prevalent. ASR systems transcribe spoken language into text, enabling users to interact with devices using voice commands. While ASR technology has improved significantly, achieving robust performance in real-world scenarios remains a critical challenge. In particular, performance degradation occurs in environments characterized by low signal-to-noise ratios (SNR), where the desired speech signal is weak relative to background noise. Further complications arise from overlapping speech, where multiple speakers are talking simultaneously. Sources of interfering sounds may include anything from ambient noises like traffic or appliance sounds, to music, or the voices of other people. These adverse acoustic conditions obscure or distort the voice of the target speaker, leading to significant errors in transcription and frustrating user experience, ultimately limiting the usability and reliability of voice-controlled devices.

### SUMMARY

One aspect of the disclosure provides a bone conducted signal-guided speech enhancement model for speech recognition. The speech enhancement model includes a stack of self-attention blocks each having a multi-head self attention mechanism. The stack of self-attention blocks is configured to: receive as input, at an initial block of the stack of self-attention blocks, an input concatenating short-time Fourier transform (STFT) coefficients for a single channel noisy input signal and upscaled STFT coefficients of a bone conducted signal (BCS) recorded by an accelerometer, and generate, as output from a final block of the stack of self-attention blocks, an un-masked output. The enhancement model includes a masking layer configured to receive, as input, the un-masked output generated as output from the final block of the stack of self-attention blocks and generate, as output, a masked single channel noisy input signal. The speech enhancement model includes an inverse STFT layer configured to receive, as input, the STFT coefficients for the single channel noisy input signal and the masked single-channel noisy input signal and generate, as output, enhanced input speech features corresponding to a target utterance.

Implementations of the disclosure may include one or more of the following optional features. In some implementations, the speech enhancement model includes a feed forward upscaling projection layer configured to receive band-limited STFT coefficients of the BCS as input and generate the upscaled STFT coefficients of the BCS as output. In these implementations, the speech enhancement model may include a down sampling block configured to receive, as input, STFT coefficients of the BCS recorded by the accelerometer and a maximum frequency bin value for sampling the BCS and generate, as output, the band-limited STFT coefficients of the BCS. Here, the down sampling block may generate the band-limited STFT coefficients of the BCS by multiplying the maximum frequency bin value by a factor of two to reduce a sampling rate of the STFT coefficients of the BCS. The feed forward upscaling projection layer, the stack of self-attention blocks, and the masking layer of the speech enhancement model are fine-tuned using a spectral loss based on an L1 loss function and L2 loss function distance between an estimated ratio mask and an ideal ratio mask and an automatic speech recognition (ASR) loss. The ASR loss is computed by generating, using an ASR encoder configured to receive enhanced speech features predicted by the speech enhancement model for a training utterance as input, predicted outputs of the ASR encoder for the enhanced speech features, generating, using the ASR encoder configured to receive target speech features for the training utterance as input, target outputs of the ASR encoder for the target speech features, and computing the ASR loss based on the predicted outputs of the ASR encoder for the enhanced speech features and the target outputs of the ASR encoder for the target speech features.

In some examples, the stack of self-attention blocks and the masking layer of the speech enhancement model are pretrained using a spectral loss based on an L1 loss function and L2 loss function distance between an estimated ratio mask and an ideal ratio mask and an ASR loss. The ideal ratio mask is computed using reverberant speech and reverberant noise. The ASR loss is computed by generating, using an ASR encoder configured to receive enhanced speech features predicted by the speech enhancement model for a training utterance as input, predicted outputs of the ASR encoder for the enhanced speech features, generating, using the ASR encoder configured to receive target speech features for the training utterance as input, target outputs of the ASR encoder for the target speech features, and computing the ASR loss based on the predicted outputs of the ASR encoder for the enhanced speech features and the target outputs of the ASR encoder for the target speech features. The stack of self-attention blocks may include a stack of Conformer blocks.

In some implementations, the speech enhancement model executes on data processing hardware residing on a user device in communication with an earbud device. The earbud device is configured to capture the target utterance via an array of microphones of the earbud device. In these implementations, the speech enhancement model may be agnostic to number of microphones in the array of microphones. In some examples, an ASR model is configured to process the enhanced input speech features corresponding to the target utterance. In these examples, a pre-trained voice activity detector (VAD) is configured to receive, as input, the BCS recorded by the accelerometer and generate, as output, an estimated speech detection value. Here, the ASR model may be configured to not process the enhanced input speech features and instead process the single channel noisy input signal when the estimated speech detection value generated as output from the VAD does not satisfy the threshold value.

Another aspect of the disclosure provides a computer-implemented method executed on data processing hardware that causes the data processing hardware to perform operations for speech enhancement. The operations include receiving, as input to an initial block of a stack of self-attention blocks of a speech enhancement model, an input concatenating short-time Fourier transform (STFT) coefficients for a single channel noisy input signal and upscaled STFT coefficients of a bone conducted signal (BCS) recorded by an accelerometer. Each self-attention block has a multi-head self attention mechanism. The operations include generating, using a final block of the stack of self-attention blocks, an un-masked output based on the input concatenating STFT coefficients for the single channel noisy input signal. The operations include generating, using a masking layer, a masked single channel noisy input signal based on the un-masked output. The operations include generating, using an inverse STFT layer, enhanced input speech features corresponding to a target utterance based on the STFT coefficients for the single channel noisy input signal and the masked single channel noisy input signal.

Implementations of the disclosure may include one or more of the following optional features. In some implementations, the operations further include receiving, as input at a feed forward upscaling projection layer, band-limited STFT coefficients of the BCS and generating, using the feed forward upscaling projection layer, the upscaled STFT coefficients of the BCS based on the band-limited STFT coefficients of the BCS. In these implementations, the operations may further include receiving, as input at a down sampling block, STFT coefficients of the BCS recorded by the accelerometer and a maximum frequency bin value for sampling the BCS and generating, using the down sampling block, the band-limited STFT coefficients of the BCS based on the STFT coefficients of the BCS and the maximum frequency bin value for sampling the BCS. Here, the down sampling block generates the band-limited STFT coefficients of the BCS by multiplying the maximum frequency bin value by a factor of two to reduce a sampling rate of the STFT coefficients of the BCS. The operations may further include fine-tuning the feed forward upscaling projection layer, the stack of self-attention blocks, and the masking layer of the speech enhancement model on a spectral loss based on an L1 loss function and L2 loss function distance between an estimated ratio mask and an ideal ratio mask and an automatic speech recognition (ASR) loss. The ASR loss is computed by generating, using an ASR encoder configured to receive enhanced speech features predicted by the speech enhancement model for a training utterance as input, predicted outputs of the ASR encoder for the enhanced speech features, generating, using the ASR encoder configured to receive target speech features for the training utterance as input, target outputs of the ASR encoder for the target speech features, and computing the ASR loss based on the predicted outputs of the ASR encoder for the enhanced speech features and the target outputs of the ASR encoder for the target speech features.

In some examples, the operations further include fine-tuning the stack of self-attention blocks and the masking layer of the speech enhancement model on a spectral loss based on an L1 loss function and L2 loss function distance between an estimated ratio mask and an ideal ratio mask and an ASR loss. The ideal ration mask is computed using reverberant speech and reverberant noise. The ASR loss is computed by generating, using an ASR encoder configured to receive enhanced speech features predicted by the speech enhancement model for a training utterance as input, predicted outputs of the ASR encoder for the enhanced speech features, generating, using the ASR encoder configured to receive target speech features for the training utterance as input, target outputs of the ASR encoder for the target speech features, and computing the ASR loss based on the predicted outputs of the ASR encoder for the enhanced speech features and the target outputs of the ASR encoder for the target speech features. The stack of self-attention blocks include a stack of Conformer blocks.

In some implementations, the speech enhancement model executes on data processing hardware residing on a user device in communication with an earbud device. The earbud device is configured to capture the target utterance via an array of microphones of the earbud device. In these implementations, the speech enhancement model is agnostic to a number of microphones in the array of microphones. In some examples, the operations further comprise processing, using an ASR model, the enhanced input speech features corresponding to the target utterance. In these examples, the operations further include generating, using a pre-trained voice activity detector (VAD), an estimated speech detection value based on the BCS recorded by the accelerometer. The ASR model is configured to process the enhanced input speech features corresponding to the target utterance when the estimated speech detection value generated as output from the VAD satisfies a threshold value. Here, the ASR model may be configured to not process the enhanced input speech features and instead process the single channel noisy input signal when the estimated speech detection value generated as output from the VAD does not satisfy the threshold value.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example system executing a speech recognition system that performs speech enhancement.

FIGS. 2A and 2B are schematic views of an example speech recognition model.

FIG. 3 is a schematic view of an example speech enhancement model.

FIG. 4 is a schematic view of an example training process for training the speech enhancement model.

FIG. 5 is a flowchart of an example arrange of operations for a computer-implemented method of performing speech enhancement.

FIG. 6 is a schematic view of an example computing device that may be used to implement the systems and methods described herein.

Like reference symbols in the various drawings indicate like elements.

### DETAILED DESCRIPTION

The increasing popularity of digital assistants has led to a surge in the use of automatic speech recognition (ASR) systems, which convert spoken language into text. This technology enables users to interact with various devices via voice commands, with earbuds emerging as a prevalent interface for digital assistants. However, the performance of ASR systems degrades significantly in the presence of noise. Environments with low signal-to-noise ratios (SNR), where background noise is substantial relative to the speech signal, cause a drop in ASR performance. Overlapping speech, instances where multiple individuals speak concurrently, also presents challenges. Interfering sounds may range from environmental noises, like traffic or operating appliances, to music or the voices of surrounding people. For example, a user attempting to issue a voice command in a busy cafe may experience poor ASR performance due to the surrounding conversations, clattering dishes, and background music. Similarly, a user dictating a message while riding a bus may find that the engine noise and road sounds interfere with accurate transcription.

These challenging acoustic environments, characterized by low SNR and/or overlapping speech, may severely degrade ASR performance. The presence of noise causes the acoustic signal of the voice of the target speaker to be obscured, distorted, or masked. This interference results in significant errors during the transcription process. This leads to a frustrating user experience, ultimately limiting the usability and reliability of voice-controlled devices. Consequently, mitigating the impact of both environmental noise and overlapping speech on ASR performance is crucial for improving the robustness and user experience of voice-controlled systems.

Accordingly, implementations herein are directed towards a bone conducted signal-guided speech enhancement model that includes a stack of self-attention blocks. The stack of self-attention blocks is configured to receive, as input, an input concatenating short-form Fourier transform (STFT) coefficients for a single channel noisy input signal (i.e., air conducted signal) and upscaled STFT coefficients of a bone conducted (BCS) recorded by an accelerometer and generate an un-masked output. The STFT coefficients of the single channel noisy input signal represent the time-frequency representation of the audio signal captured by a microphone, which includes both the target speech and any background noise. The STFT coefficients of the BCS signal similarly represent the time-frequency representation of the vibrations sensed by the accelerometer, which are primarily caused by the speech spoken by the user. The speech enhancement model includes a masking layer configured to receive, as input, the un-masked output and generate a masked single channel noisy input signal. The speech enhancement model includes an inverse STFT layer configured to generate enhanced input speech features corresponding to a target utterance.

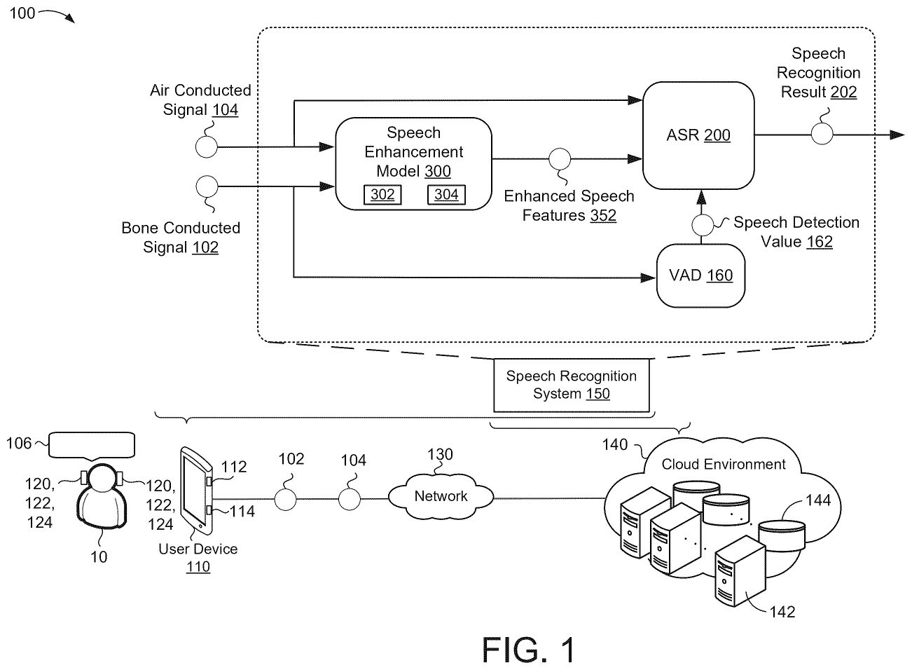

Referring to FIG. 1, in some implementations, a system 100 includes a remote computing system 140 in communication with one or more user devices 110 each associated with a respective user 10 via a network 130, such as the Internet, a local area network (LAN), a wide area network (WAN), a cellular network, or a wireless network. The remote computing system 140 may be a single computer, multiple computers, or a distributed system (e.g., a cloud environment) having scalable/elastic resources including computing resources 142 (e.g., data processing hardware) and/or storage resources 144 (e.g., memory hardware). The remote computing system 140 is configured to communicate with the user device 110 via the network 130.

The user device 110 may correspond to any computing device, such as a desktop workstation, a laptop workstation, a mobile device (i.e., a smart phone), or a wearable device (i.e., a smartwatch). Each user device 110 includes computing resources 112 (e.g., data processing hardware) and/or storage resources 114 (e.g., memory hardware). The user device 110 may also include an audio input device (e.g., a microphone) and an audio output device (e.g., a speaker) for capturing and playing audio data, respectively. The user device 110 may further include a display device (e.g., a screen) for presenting visual information to the user 10.

The user device 110 may also be in communication with an earbud device 120, which may include, but is not limited to, earbuds, headphones, or any other listening device designed to be worn in or around the user's 10 ear. The earbud device 120 may include an array of microphones 122 configured to capture a target utterance 106 spoken by the user 10. These microphones 122 are sensitive to pressure variations in the air caused by sound waves, including both the target utterance 106 and any ambient noise. The earbud device 120, or the user device 110, may convert the target utterance 106, captured by the array of microphones 122, into a single channel noisy input signal 104. That is, the single channel noisy input signal 104 may be based on a single microphone 122 from the array of microphones 122 or represent a combination (e.g., a weighted average, or a selection of the microphone with the best signal-to-noise ratio) of the signals from the array of microphones 122. Additionally or alternatively, the user device 110 may include an array of microphones that capture the target utterance 106. The single channel noisy input signal 104 is an air-conducted signal, representing the sound waves that travel through the air.

Moreover, the earbud device 120 may include one or more accelerometers 124 configured to measure bone conduction signals (BCS) 102, When the earbud device 120 is a set of earbuds, each earbud may include a respective accelerometer 124. Each accelerometer 124 may be positioned to detect vibrations of the user's 10 skull (or other bones in the head or neck) caused by vocal chord activity and the subsequent vibration of bones in the head or neck. This configuration allows the accelerometer 124 to directly capture the target utterance 106, resulting in a signal that is less susceptible to interference from environmental sounds. The accelerometer 124 generates a signal that is representative of the sound conducted through the bones of the user, as opposed to the air. For example, if the user 10 is speaking in a noisy environment, such as a crowded train station, the array of microphones 122 will pick up both the voice of the user 10 and the surrounding noise (e.g., train announcements, conversations, etc.). However, the accelerometer 124 will primarily pick up the vibrations from the voice of the user 10, providing a cleaner signal of the user's 10 speech. This is because bone conduction primarily transmits the vibrations of the voice of the user 10, while being less sensitive to airborne sounds. The BCS 102 generally has a higher signal-to-noise ratio than the air-conducted microphone signal in noisy environments, particularly for lower frequencies of the speech signal.

A speech recognition system 150 executes on the user device 110 and/or the remote system 140. In some examples, some components of the speech recognition system 150 execute on the user device 110 while other components execute on the remote system 140. For instance, the speech recognition system 150 may include a BCS-guided speech enhancement model (i.e., speech enhancement model) 300 that executes on the data processing hardware 112 of the user device 110 that is in communication with the earbud device 120. The earbud device 120 is configured to capture the target utterance 106 spoken by the user 10 via the array of microphones 122 (e.g., the noisy input signal 104) and the accelerometer 124 (e.g., the BCS 102). The speech recognition system 150 may also include a voice activity detector (VAD) 160 and an automatic speech recognition (ASR) model 200. The speech enhancement model 300 is configured to receive, as input, the single channel noisy input signal 104 (e.g., captured by the array of microphones 122) and the BCS 102 recorded by the accelerometer 124 and generate, as output, enhanced input speech features 352. Notably, in some examples, the speech enhancement model 300 is agnostic to a number of microphones 122 in the array of microphones 122. In some implementations, the speech enhancement model 300 generates short-time Fourier transform (STFT) coefficients for the single channel noisy input signal 304 based on the single channel noisy input signal (e.g., air conducted signal) 104 and STFT coefficients of the BCS 302 based on the BCS 102. The STFT coefficients provide a time-frequency representation of the signals, allowing the speech enhancement model 300 to analyze and process the speech and noise components in different frequency bands.

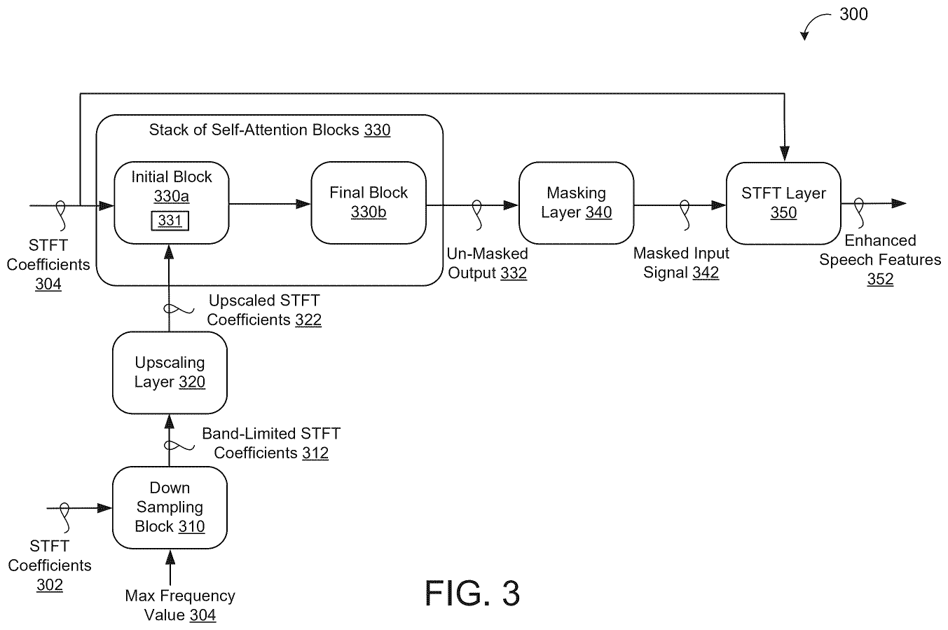

Referring now to FIG. 3, the speech enhancement model 300 is configured to receive, as input, STFT coefficients of the BCS 302 and STFT coefficients for a single channel noisy input signal 304 and generate, as output, enhanced speech features 352. More specifically, the speech enhancement model 300 includes a down sampling block 310 configured to receive, as input, the STFT coefficients of the BCS 302 and a maximum frequency bin value 306 for sampling the BCS 102 and generate, as output, band-limited STFT coefficients of the BCS 312. The STFT coefficients of the BCS 302 represent the frequency context of the BCS 102 over short, overlapping time windows. Each coefficient represents the magnitude and phase of a specific frequency component at a specific time window. The maximum frequency bin value 306 indicates the highest frequency component considered relevant in the BCS 102. Thus, the maximum frequency bin value 306 is important for determining the extent of down sampling to apply. In short, the down sampling block 310 generates the band-limited STFT coefficients of the BCS 312 based on the STFT coefficients of the BCS 302. The down sampling block 310 may generate the band-limited STFT coefficients of the BCS 312 by effectively discarding frequency information above the frequency indicated by the maximum frequency bin value 306. This is done because higher frequency components in a bone-conducted signal are often heavily attenuated and contain more noise than useful speech information. One way to achieve this is by the down sampling block 310 multiplying the maximum frequency bin value 306 by a factor of two to reduce a sampling rate of the STFT coefficients of the BCS 302.

In some examples, the speech enhancement model 300 generates the STFT coefficients of the BCS 302 by applying a Fourier transform on the BCS 102. In other examples, the down sampling block 310 generates the STFT coefficients of the BCS 302 by applying the Fourier transform on the BCS 102. The speech enhancement model 300 includes a feed forward upscaling projection layer 320 that is configured to receive, as input, the band-limited STFT coefficients of the BCS 312 generated by the down sampling block 310 and generate, as output, upscaled STFT coefficients of the BCS 322. The feed forward upscaling projection layer 320 serves to project the down sampled band-limited STFT coefficients of the BCS 312 back to a higher-dimensional space. This projection helps to restore some of the frequency information that may have been lost during down sampling, allowing the subsequent self-attention blocks 330 to better integrate information from both the noisy input signal and the BCS 102.

The speech enhancement model 300 includes a stack of self-attention blocks 330. Each self-attention block 330 in the stack of self-attention blocks 330 has a multi-head self attention mechanism. This mechanism allows the speech enhancement model 300 to weigh the importance of different parts of the input sequence differently, capturing long-range dependencies within the audio data. In some examples, the stack of self-attention blocks 330 includes a stack of Conformer blocks. An initial block 330, 330a (or an initial set of blocks) of the stack of self-attention blocks 330 is configured to receive, as input, an input 331 concatenating STFT coefficients for a single channel noisy input signal 304 and the upscaled STFT coefficients of the BCS 322 recorded by the accelerometer 124. The input 331 concatenates the information from the single channel noisy input signal 104 and the BCS 102, providing the stack of self-attention blocks 330 with both perspectives of the speech. For example, the noisy signal input signal 104 may include clear speech information in certain frequency ranges, while the BCS 102 includes higher quality information in other frequency ranges where the noisy input signal 104 is corrupted. The self-attention mechanism may learn to selectively attend to the more reliable source for each time-frequency region. A final block 330, 330b (or a final set of blocks) of the stack of self-attention blocks 330 is configured to generate an un-masked output 332 based on the input 331. The un-masked output 332 represents a refined representation of the input 331, where the stack of self-attention blocks 330 have integrated information from both the noisy input signal 104 and the BCS 102. More specifically, the stack of self-attention blocks 330 learn to weigh and combine the information from the two input sources (e.g., the air-conducted and bone-conducted signals) based on their respective reliabilities at different time-frequency bins. The weighted combination helps to create a more robust representation of the underlying speech signal.

A masking layer 340 of the speech enhancement model 300 is configured to receive, as input, the un-masked output 332 generated as output from the final block 330b of the stack of self-attention blocks 330 and generate, as output, a masked single channel noisy input signal 342 based on the un-masked output 332. The masking layer 340 may estimate an estimated ratio mask (e.g., time-frequency mask) 344. The estimated ratio mask 344 is a matrix of values, typically between 0 and 1, where each value corresponds to a specific time-frequency bin in the STFT coefficients for the single channel noisy input signal 104. A value close to 1 may indicate that the speech signal is likely dominant in that time-frequency bin, while a value close to 0 indicates that noise is likely dominant. In some examples, the masking layer 340 effectively acts as a filter that selectively emphasizes time-frequency regions where the target speech is likely dominant and suppresses regions dominated by noise. The masking layer 340 filters by element-wise multiplication of the STFT coefficients of the noisy input signal 104 by the estimated ratio mask 344. Thus, the masked single-channel noisy input 342 represents the STFT coefficients for the single channel noisy input signal 104 after being filtered by the estimated ratio mask 344.

An inverse STFT layer 350 of the speech enhancement model 300 is configured to receive, as input, the masked single-channel noisy input signal 342 and generate, as output, enhanced speech features 352 corresponding to a target utterance 106 (FIG. 1) based on the masked single-channel noisy input signal 342. The masked single-channel noisy input signal 342 represents the frequency-domain representation of the speech signal after noise suppression, where the magnitudes of the STFT coefficients have been adjusted by the masking layer 340. The inverse STFT layer 350 converts the masked STFT coefficients back into the time domain, resulting in the enhanced speech features 352. In some examples, the inverse STFT layer 350 generates the enhanced speech features 352 further based on the STFT coefficients for the single channel noisy input signal 304. In these examples, the phase information from the STFT coefficients for the single channel noisy input signal 304 may be combined with the magnitude information from the masked single-channel noisy input 342. This may improve the quality of the reconstructed speech, as the original phase information is often less corrupted by noise than the magnitude. The resulting enhanced speech features 352 are a time-domain representation of the cleaned-up audio signal, where the noise has been significantly reduced, and the target utterance is more prominent.

Referring back to FIG. 1, in some examples, the ASR model 200 is configured to process the enhanced input speech features 352 corresponding to the target utterance 106 to generate corresponding speech recognition results 202. However, not all BCSs 102 include useful speech information. That is, in some instances distortions occur that mask speech information in the BCS 102. To that end, the VAD 160 is configured to receive, as input, the BCS 102 recorded by the accelerometer 124 and generate, as output, an estimated speech detection value 162. The estimated speech detection value 162 may be a numerical score representing the probability or likelihood that speech is present in the BCS 102. Here, the ASR model 200 is configured to process the enhanced input speech features 352 corresponding to the target utterance 106 when the estimated speech detection value 162 generated as output from the VAD 160 satisfies a threshold value. The threshold value represents a predetermined level of confidence in the presence of speech. For instance, the threshold value may be set to 0.8, meaning that the ASR model 200 will only process the enhanced input speech features 352 if the VAD 160 determines there is at least an 80% probability that speech is present in the BCS 102.

On the other hand, when the estimated speech detection value 162 generated as output from the VAD 160 does not satisfy the threshold value, the ASR model 200 may be configured to take alternative actions. Instead of processing the enhanced input speech signal 352, the ASR model 200 may process the single channel noisy input signal 104. Notably, this may be useful in scenarios where the enhancement process itself introduces artifacts or distortion, or where the BCS 102 is unavailable or unreliable. Processing the noisy input signal 104, while potentially noisier, may still be useful. Alternatively, when the estimated speech detection value 162 does not satisfy the threshold value, the ASR model 200 may process the single channel noisy input signal 104 and remain in an idle state (e.g., not performing speech recognition to conserve processing power) based on determining that speech is not present.

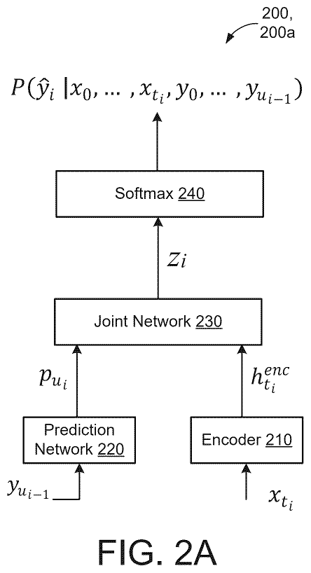

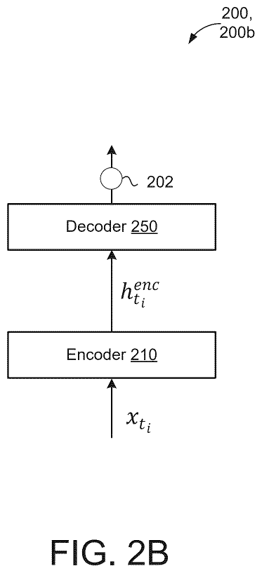

Referring now to FIG. 2A, in some implementations, an example ASR model 200, 200a includes a Recurrent Neural Network-Transducer (RNN-T) model architecture which adheres to latency constraints with interactive applications. The use of the RNN-T model architecture is exemplary only, as the ASR model 200a may include other architectures such as transformer-transducer and conformer-transducer model architectures, among others. The RNN-T model provides a small computational footprint and utilizes less memory requirements than conventional ASR architectures, making the RNN-T model architecture suitable for performing speech recognition entirely on the user device 110 (e.g., no communication with a remote server is required). The RNN-T model architecture of the ASR model 200a includes an encoder network (e.g., ASR encoder) 210, a prediction network 220, and a joint network 230. The encoder network 210, which is roughly analogous to an acoustic model (AM) in a traditional ASR system, includes a stack of self-attention layers (e.g., Conformer or Transformer layers) or a recurrent network of stacked Long Short-Term Memory (LSTM) layers. For instance, audio encoder 210 reads a sequence of d-dimensional feature vectors (e.g., air conducted signal 104 or enhanced speech features 352) x=(x₁, x₂, . . . , x_{T}), where xₜ∈R_{d}, and produces at each output step a higher-order feature representation (e.g., audio encoding). This higher-order feature representation is denoted as h₁^{enc}, . . . , h_{T}^{enc}.

Similarly, the prediction network 220 is also an LSTM network, which, like a language model (LM), processes the sequence of non-blank symbols output by a final Softmax layer 240 so far, y₀, . . . , yᵤᵢ₋₁, into a dense representation pᵤ_{ᵢ}. Finally, with the RNN-T model architecture, the representations produced by the encoder and prediction/decoder networks 210, 220 are combined by the joint network 230. The prediction network 220 may be replaced by an embedding look-up table to improve latency by outputting looked-up sparse embeddings in lieu of processing dense representations. The joint network 230 then predicts P(yᵢ|xₜ_{ᵢ}, y₀, . . . , yᵤ_{_{−1}}), which is a distribution over the next output symbol. Stated differently, the joint network 230 generates, at each output step (e.g., time step), a probability distribution over possible speech recognition hypotheses. Here, the “possible speech recognition hypotheses” correspond to a set of output labels each representing a symbol/character in a specified natural language. For example, when the natural language is English, the set of output labels may include twenty-seven (27) symbols, e.g., one label for each of the 26-letters in the English alphabet and one label designating a space. Accordingly, the joint network 330 may output a set of values indicative of the likelihood of occurrence of each of a predetermined set of output labels. This set of values may be a vector that indicates a probability distribution over the set of output labels. In some cases, the output labels are graphemes (e.g., individual characters, and potentially punctuation and other symbols), but the set of output labels is not so limited. For example, the set of output labels may include wordpieces, phonemes, and/or entire words, in addition to or instead of graphemes. The output distribution of the joint network 230 can include a posterior probability value for each of the different output labels. Thus, if there are 100 different output labels representing different graphemes or other symbols, the output yᵢ of the joint network 230 can include 100 different probability values, one for each output label. The probability distribution can then be used to select and assign scores to candidate orthographic elements (e.g., graphemes, wordpieces, and/or words) in a beam search process (e.g., by the Softmax layer 240) for determining the speech recognition result.

The Softmax layer 240 may employ any technique to select the output label/symbol with the highest probability in the distribution as the next output symbol predicted by the ASR model 200a at the corresponding output step. In this manner, the ASR model 200a does not make a conditional independence assumption, rather the prediction of each symbol is conditioned not only on the acoustics, but also on the sequence of labels output so far. The ASR model 200a does assume an output symbol is independent of future acoustic frames, which allows the RNN-T model architecture of the ASR model 200a to be employed in the streaming fashion, the non-streaming fashion, or some combination thereof.

In some examples, the audio encoder 210 of the RNN-T model includes a plurality of multi-head (e.g., 8 heads) self-attention layers. For example, the plurality of multi-head self-attention layers may include Conformer layers (e.g., Conformer-encoder), transformer layers, performer layers, convolution layers (including lightweight convolution layers), or any other type of multi-head self-attention layers. The plurality of multi-head self-attention layers may include any number of layers, for instance, 16 layers. Moreover, the audio encoder 210 may operate in the streaming fashion (e.g., the audio encoder 210 outputs initial higher-order feature representations as soon as they are generated), in the non-streaming fashion (e.g., the audio encoder 210 outputs subsequent higher-order feature representations by processing additional right-context to improve initial higher-order feature representations), or in a combination of both the streaming and non-streaming fashion.

Referring now to FIG. 2B, in some implementations, an example ASR model 200, 200b includes an encoder-decoder architecture. The encoder network 210, which is roughly analogous to an acoustic model (AM) in a traditional ASR system, includes a stack of self-attention layers (e.g., Conformer or Transformer layers) or a recurrent network of stacked Long Short-Term Memory (LSTM) layers. For instance, audio encoder 210 reads a sequence of d-dimensional feature vectors (e.g., air conducted signal 104 or enhanced speech features 352) x=(x₁, x₂, . . . , x_{T}), where xₜ∈R_{d}, and produces at each output step a higher-order feature representation (e.g., audio encoding). This higher-order feature representation is denoted as h₁^{enc}, . . . , h_{T}^{enc}. The decoder 250 processes the higher-order feature representation generated by the ASR encoder 210 to generate a speech recognition result. In some examples, the decoder 250 includes a sequence processing neural network. The sequence processing neural network may be a large language model (LLM). For simplicity, the present disclosure will refer to the sequence processing neural network as an LLM, however, the sequence processing neural network may include other types of sequence processing neural networks other than LLMs without departing from the scope of the present disclosure.

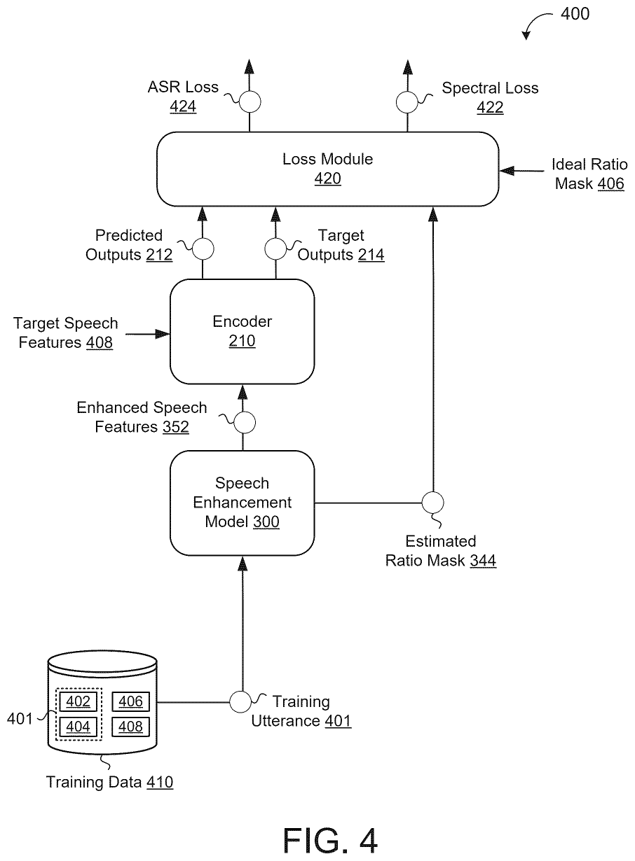

FIG. 4 illustrates an example training process 400 for training the speech enhancement model 300. The training process 400 obtains training data 410 that includes a plurality of training utterances 401. Each training utterance 401 may be represented by training STFT coefficients of a BCS 402 and/or training STFT coefficients for a single channel noisy input 404. The STFT coefficients, as described above, provide a time-frequency representation of the training utterance 301, showing how the frequency content changes over time. Moreover, each training utterance 401 may be paired with an ideal ratio mask 406 and target speech features 408. The ideal ratio mask 406 represents a ground-truth label of which time-frequency bins in the noisy signal include primarily speech and which include primarily noise. In some examples, the training process 400 generates the ideal ratio mask 406 using clean speech signals. The target speech features 408 represent clean or noise-free versions of the training utterances 401. Thus, the target speech features 408 represent the ground-truth output the speech enhancement model 300 aims to produce.

For each training utterance 401 of the plurality of training utterances 401, the speech enhancement model 300 processes the training utterance 401 (e.g., processes the training STFT coefficients of the BCS 402 and the training STFT coefficients for the single channel noisy input 404 in a similar manner as described in FIG. 3) to generate a corresponding estimated ratio mask 344. The estimated ratio mask 344 is the prediction by the speech enhancement model 300 of the ideal ratio mask 406. A loss module receives the estimated ratio mask 344 and the ideal ratio mask 406 and determines a spectral loss 422 based on an L1 loss function and L2 loss function distance between the estimated ratio mask 344 and the ideal ratio mask 406. The L1 loss function (e.g., mean absolute error function) determines the average absolute difference between the values in the estimated ratio mask 344 and the ideal ratio mask 406. The L2 loss function (e.g., the mean squared error) determines the average of the squared differences. Using both L1 and L2 functions provides a more robust training process, as L1 loss function is less sensitive to outliers, while L2 loss function penalizes larger errors more heavily. Therefore, the spectral loss 422 quantifies how well the speech enhancement model 300 estimates the time-frequency mask (e.g., estimated ratio mask 344) that separates speech from noise.

Moreover, for each training utterance 401 of the plurality of training utterances 401, the speech enhancement model 300 processes the training utterance 401 (e.g., processes the training STFT coefficients of the BCS 402 and the training STFT coefficients for the single channel noisy input 404 in a similar manner as described in FIG. 3) to generate enhanced speech features 352. The ASR encoder 210 is configured to receive enhanced speech features 352 predicted by the speech enhancement model 300 for a training utterance 401 as input, and generate predicted outputs 412 of the ASR encoder 210 for the enhanced speech features 352. The ASR encoder 210 is further configured to receive the target speech features 408 for the training utterance 401 as input, and generate target outputs 214 of the ASR encoder 210 for the target speech features 408. The loss module 420 computes an ASR loss 424 based on the predicted outputs 212 of the ASR encoder 210 for the enhanced speech features 352 and the target outputs 214 of the ASR encoder 210 for the target speech features 408. The ASR loss 424 quantifies the difference between the output by the ASR encoder 210 when processing the enhanced speech features 352 and the output by the ASR encoder 210 when processing the target speech features 408. The training process 400 may fine-tune the feed forward upscaling projection layer 320, the stack of self-attention blocks 330, and the masking layer 340 of the speech enhancement model 300 on the spectral loss 422 and/or the ASR loss 424.

In some implementations, the training process 400 computes the ideal ratio mask 406 using reverberant speech and reverberant noise. Reverberant speech refers to the speech signal after it has been affected by reflections within an environment (e.g., a room). Similarly, reverberant noise is noise that has been reflected off surfaces. In this scenario, the training process 400 may determine the spectral loss 422 and the ASR loss 424 as described above but for the ideal ratio mask 406 computed using the reverberant speech and the reverberant noise. This simulates a more realistic acoustic environment compared to using anechoic (i.e., reflection-free) speech and noise used during the fine-tuning process. In this scenario, (i.e., the reverberant speech and reverberant noise scenario) the training process 400 may pre-train the stack of self-attention blocks 330 and the masking layer 340 of the speech enhancement model 300 on the spectral loss 422 and the ASR loss 424. Pre-training, in this context, means that these components of the speech enhancement model 300 are trained first using the reverberant data, before any further fine-tuning with other types of data or training objectives. Pre-training helps the speech enhancement model 300 learn to handle the complexities of reverberation, such as time delays and spectral distortions caused by sound reflections. After pre-training, the training process 400 may further train (e.g., fine-tune) the speech enhancement model 300 using a dataset that includes a broader range of acoustic conditions (e.g., outdoor environments, different room sizes, etc.).

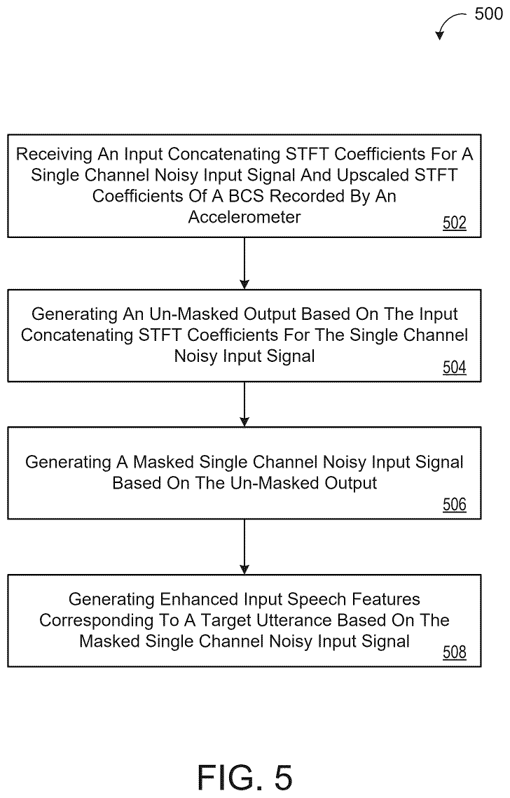

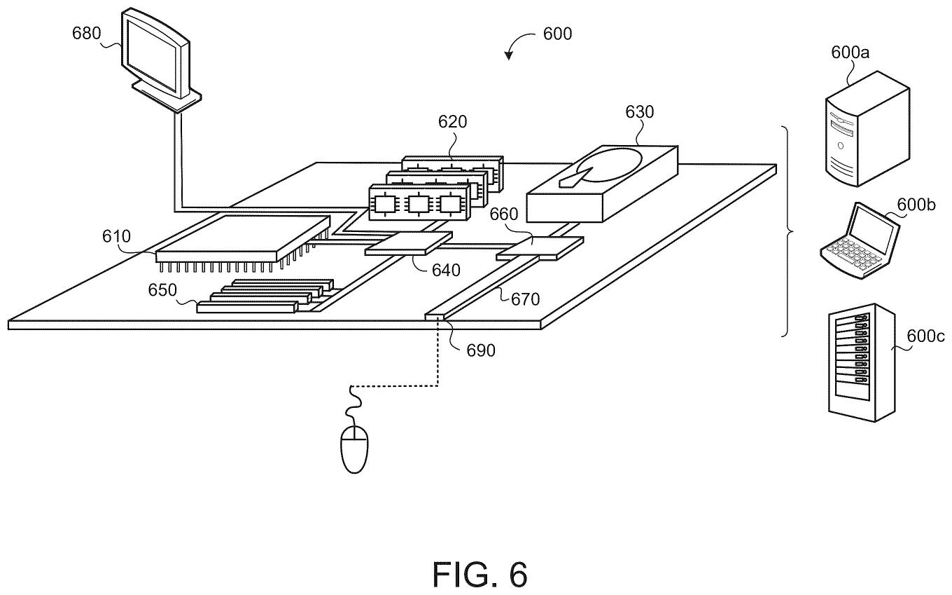

FIG. 5 is a flowchart of an example arrangement of operations for a computer-implemented method 500 for speech enhancement. The method 500 may execute on data processing hardware 610 (FIG. 6) using instructions stored on memory hardware 620 (FIG. 6). The data processing hardware 610 and the memory hardware 620 may reside on the user device 110 and/or the remote system 140 of FIG. 1 each corresponding to the computing device 600 (FIG. 6).

At operation 502, the method 500 includes receiving, as input to an initial block 330a of a stack of self-attention blocks 330 of a speech enhancement model 300, an input 331 concatenating STFT coefficients for a single channel noisy input signal 304 and upscaled STFT coefficients of a BCS 322 recorded by an accelerometer 124. Each block 330 of the stack of self-attention blocks 330 has a multi-head self attention mechanism. At operation 504, the method 500 includes generating, using a final block 330b of the stack of self-attention blocks 330, an un-masked output 332 based on the input 331 concatenating STFT coefficients for the single channel noisy input signal and the upscaled STFT coefficients of the BCS 322. At operation 506, the method 500 includes generating, using a masking layer 340, a masked single channel noisy input signal 342 based on the un-masked output 332. At operation 508, the method 500 includes generating, using an inverse STFT layer 350, enhanced input speech features 352 corresponding to a target utterance 106 based on the STFT coefficients for the single channel noisy input signal 304 and the masked single channel noisy input signal 342.

FIG. 6 is a schematic view of an example computing device 600 that may be used to implement the systems and methods described in this document. The computing device 600 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 600 includes a processor 610, memory 620, a storage device 630, a high-speed interface/controller 640 connecting to the memory 620 and high-speed expansion ports 650, and a low speed interface/controller 660 connecting to a low speed bus 670 and a storage device 630. Each of the components 610, 620, 630, 640, 650, and 660, are interconnected using various busses, and may be mounted on a common motherboard or in other manners as appropriate. The processor 610 can process instructions for execution within the computing device 600, including instructions stored in the memory 620 or on the storage device 630 to display graphical information for a graphical user interface (GUI) on an external input/output device, such as display 680 coupled to high speed interface 640. In other implementations, multiple processors and/or multiple buses may be used, as appropriate, along with multiple memories and types of memory. Also, multiple computing devices 600 may be connected, with each device providing portions of the necessary operations (e.g., as a server bank, a group of blade servers, or a multi-processor system).

The memory 620 stores information non-transitorily within the computing device 600. The memory 620 may be a computer-readable medium, a volatile memory unit(s), or non-volatile memory unit(s). The non-transitory memory 620 may be physical devices used to store programs (e.g., sequences of instructions) or data (e.g., program state information) on a temporary or permanent basis for use by the computing device 600. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 630 is capable of providing mass storage for the computing device 600. In some implementations, the storage device 630 is a computer-readable medium. In various different implementations, the storage device 630 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier The computer program product contains instructions that, when executed, perform one or more methods, such as those described above. The information carrier is a computer- or machine-readable medium, such as the memory 620, the storage device 630, or memory on processor 610.

The high speed controller 640 manages bandwidth-intensive operations for the computing device 600, while the low speed controller 660 manages lower bandwidth-intensive operations. Such allocation of duties is exemplary only. In some implementations, the high-speed controller 640 is coupled to the memory 620, the display 680 (e.g., through a graphics processor or accelerator), and to the high-speed expansion ports 650, which may accept various expansion cards (not shown). In some implementations, the low-speed controller 660 is coupled to the storage device 630 and a low-speed expansion port 690. The low-speed expansion port 690, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 600a or multiple times in a group of such servers 600a, as a laptop computer 600b, or as part of a rack server system 600c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks, The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A bone conducted signal-guided speech enhancement model for speech recognition, the speech enhancement model comprising:
a stack of self-attention blocks each having a multi-head self attention mechanism, the stack of self-attention blocks configured to:
receive as input, at an initial block of the stack of self-attention blocks, an input concatenating short-time Fourier transform (STFT) coefficients for a single channel noisy input signal and upscaled STFT coefficients of a bone conducted signal (BCS) recorded by an accelerometer; and
generate, as output from a final block of the stack of self-attention blocks, an un-masked output; and
a masking layer configured to:
receive, as input, the un-masked output generated as output from the final block of the stack of self-attention blocks; and
generate, as output, a masked single channel noisy input signal; and
an inverse STFT layer configured to:
receive, as input, the STFT coefficients for the single channel noisy input signal and the masked single channel noisy input signal; and
generate, as output, enhanced input speech features corresponding to a target utterance.

2. The speech enhancement model of claim 1, further comprising a feed forward upscaling projection layer configured to:
receive, as input, band-limited STFT coefficients of the BCS; and
generate, as output, the upscaled STFT coefficients of the BCS.

3. The speech enhancement model of claim 2, further comprising a down sampling block configured to:
receive, as input, STFT coefficients of the BCS recorded by the accelerometer and a maximum frequency bin value for sampling the BCS, and
generate, as output, the band-limited STFT coefficients of the BCS.

4. The speech enhancement model of claim 3, wherein the down sampling block generates the band-limited STFT coefficients of the BCS by multiplying the maximum frequency bin value by a factor of two to reduce a sampling rate of the STFT coefficients of the BCS.

5. The speech enhancement model of claim 3, wherein the feed forward upscaling projection layer, the stack of self-attention blocks, and the masking layer of the speech enhancement model are fine-tuned using:
a spectral loss based on an L1 loss function and L2 loss function distance between an estimated ratio mask and an ideal ratio mask, and
an automatic speech recognition (ASR) loss computed by:
generating, using an ASR encoder configured to receive enhanced speech features predicted by the speech enhancement model for a training utterance as input, predicted outputs of the ASR encoder for the enhanced speech features;
generating, using the ASR encoder configured to receive target speech features for the training utterance as input, target outputs of the ASR encoder for the target speech features; and
computing the ASR loss based on the predicted outputs of the ASR encoder for the enhanced speech features and the target outputs of the ASR encoder for the target speech features.

6. The speech enhancement model of claim 1, wherein the stack of self-attention blocks and the masking layer of the speech enhancement model are pretrained using:
a spectral loss based on an L1 loss function and L2 loss function distance between an estimated ratio mask and an ideal ratio mask, the ideal ratio mask computed using reverberant speech and reverberant noise; and
an automatic speech recognition (ASR) loss computed by:
generating, using an ASR encoder configured to receive enhanced speech features predicted by the speech enhancement model for a training utterance as input, predicted outputs of the ASR encoder for the enhanced speech features;
generating, using the ASR encoder configured to receive target speech features for the training utterance as input, target outputs of the ASR encoder for the target speech features; and
computing the ASR loss based on the predicted outputs of the ASR encoder for the enhanced speech features and the target outputs of the ASR encoder for the target speech features.

7. The speech enhancement model of claim 1, wherein the stack of self-attention blocks comprises a stack of Conformer blocks.

8. The speech enhancement model of claim 1, wherein the speech enhancement model executes on data processing hardware residing on a user device in communication with an earbud device, the earbud device configured to capture the target utterance via an array of microphones of the earbud device.

9. The speech enhancement model of claim 8, wherein the speech enhancement model is agnostic to a number of microphones in the array of microphones.

10. The speech enhancement model of claim 1, wherein an automatic speech recognition (ASR) model is configured to process the enhanced input speech features corresponding to the target utterance.

11. The speech enhancement model of claim 10, wherein a pre-trained voice activity detector (VAD) is configured to:
receive, as input, the BCS recorded by the accelerometer; and
generate, as output, an estimated speech detection value,
wherein the ASR model is configured to process the enhanced input speech features corresponding to the target utterance when the estimated speech detection value generated as output from the VAD satisfies a threshold value.

12. The speech enhancement model of claim 11, wherein, when the estimated speech detection value generated as output from the VAD does not satisfy the threshold value, the ASR model is configured to not process the enhanced input speech features and instead process the single channel noisy input signal.

13. A computer-implemented method executed on data processing hardware that causes the data processing hardware to perform operations comprising:
receiving, as input to an initial block of a stack of self-attention blocks of a speech enhancement model, an input concatenating short-time Fourier transform (STFT) coefficients for a single channel noisy input signal and upscaled STFT coefficients of a bone conducted signal (BCS) recorded by an accelerometer, each self-attention block having a multi-head self attention mechanism;
generating, using a final block of the stack of self-attention blocks, an un-masked output based on the input concatenating STFT coefficients for the single channel noisy input signal and the upscaled STFT coefficients of the BCS;
generating, using a masking layer, a masked single channel noisy input signal based on the un-masked output; and
generating, using an inverse STFT layer, enhanced input speech features corresponding to a target utterance based on the STFT coefficients for the single channel noisy input signal and the masked single channel noisy input signal.

14. The computer-implemented method of claim 13, wherein the operations further comprise:
receiving, as input at a feed forward upscaling projection layer, band-limited STFT coefficients of the BCS; and
generating, using the feed forward upscaling projection layer, the upscaled STIFT coefficients of the BCS based on the band-limited STFT coefficients of the BCS.

15. The computer-implemented method of claim 14, wherein the operations further comprise:
receiving, as input at a down sampling block, STFT coefficients of the BCS recorded by the accelerometer and a maximum frequency bin value for sampling the BCS; and
generating, using the down sampling block, the band-limited STFT coefficients of the BCS based on the STFT coefficients of the BCS and the maximum frequency bin value for sampling the BCS.

16. The computer-implemented method of claim 15, wherein the down sampling block generates the band-limited STFT coefficients of the BCS by multiplying the maximum frequency bin value by a factor of two to reduce a sampling rate of the STFT coefficients of the BCS.

17. The computer-implemented method of claim 15, wherein the operations further comprise fine-tuning the feed forward upscaling projection layer, the stack of self-attention blocks, and the masking layer of the speech enhancement model on:
a spectral loss based on an L1 loss function and L2 loss function distance between an estimated ratio mask and an ideal ratio mask; and
an automatic speech recognition (ASR) loss computed by:
generating, using an ASR encoder configured to receive enhanced speech features predicted by the speech enhancement model for a training utterance as input, predicted outputs of the ASR encoder for the enhanced speech features;
generating, using the ASR encoder configured to receive target speech features for the training utterance as input, target outputs of the ASR encoder for the target speech features; and
computing the ASR loss based on the predicted outputs of the ASR encoder for the enhanced speech features and the target outputs of the ASR encoder for the target speech features.

18. The computer-implemented method of claim 13, wherein the operations further comprise fine-tuning the stack of self-attention blocks and the masking layer of the speech enhancement model on:
a spectral loss based on an L1 loss function and L2 loss function distance between an estimated ratio mask and an ideal ratio mask, the ideal ratio mask computed using reverberant speech and reverberant noise; and
an automatic speech recognition (ASR) loss computed by:
generating, using an ASR encoder configured to receive enhanced speech features predicted by the speech enhancement model for a training utterance as input, predicted outputs of the ASR encoder for the enhanced speech features;
generating, using the ASR encoder configured to receive target speech features for the training utterance as input, target outputs of the ASR encoder for the target speech features; and
computing the ASR loss based on the predicted outputs of the ASR encoder for the enhanced speech features and the target outputs of the ASR encoder for the target speech features.

19. The computer-implemented method of claim 13, wherein the stack of self-attention blocks comprises a stack of Conformer blocks.

20. The computer-implemented method of claim 13, wherein the speech enhancement model executes on data processing hardware residing on a user device in communication with an earbud device, the earbud device configured to capture the target utterance via an array of microphones of the earbud device.

21. The computer-implemented method of claim 20, wherein the speech enhancement model is agnostic to a number of microphones in the array of microphones.

22. The computer-implemented method of claim 13, wherein the operations further comprise processing, using an automatic speech recognition (ASR) model, the enhanced input speech features corresponding to the target utterance.

23. The computer-implemented method of claim 22, wherein the operations further comprise:
generating, using a pre-trained voice activity detector (VAD), an estimated speech detection value based on the BCS recorded by the accelerometer,
wherein the ASR model is configured to process the enhanced input speech features corresponding to the target utterance when the estimated speech detection value generated as output from the VAD satisfies a threshold value.

24. The computer-implemented method of claim 23, wherein, when the estimated speech detection value generated as output from the VAD does not satisfy the threshold value, the ASR model is configured to not process the enhanced input speech features and instead process the single channel noisy input signal.
